(19) United States
(12) Patent Application Publication
(10) Pub. No.: US 2026/0142275 A1
(43) Pub. Date: May 21, 2026

(54) PHOTONIC ENHANCED BATTERY

(71) Applicant: The Ideation and Actualization Project LLC, Draper, UT (US)

(72) Inventor: John Stuart Neuman, Draper, UT (US)

(21) Appl. No.: 19/388,731

(22) Filed: Nov. 13, 2025

Related U.S. Application Data
(60) Provisional application No. 63/722,682, filed on Nov. 20, 2024.

(51) Int. Cl. H01M 10/657; G02B 6/10; H02J 7/00

(52) U.S. Cl. CPC H01M 10/657; G02B 6/102; G02B 6/105; H02J 7/685

(57) ABSTRACT

A photonic enhanced battery is provided. A rechargeable battery can include one or more cells that incorporate one or more optical waveguides that deliver electromagnetic radiation into the cell. The electromagnetic radiation can improve ionic transport, heat the cell, suppress dendrite formation or growth and/or enhance micro-gap conductivity. An optical waveguide may be coupled at an edge of the cell's separator to direct the electromagnetic radiation between the cell's electrodes.

### CROSS-REFERENCE TO RELATED APPLICATIONS

This application claims the benefit of U.S. Provisional Ser. No. 63/722,682 filed Nov. 20, 2024.

### BACKGROUND

FIGS. 1A and 1B each show a battery 100 with a common battery cell structure. Battery includes a first electrode 110 consisting of cathode 111 and a current collector 112, a second electrode 120 consisting of anode 121 and a current collector 122, a separator 130 positioned between cathode 111 and anode 121 and a casing 140 that surrounds the cathode 111, anode 121 and separator 130. In FIG. 1A, separator 130 represents a solid electrolyte, whereas in FIG. 1B, separator 130 represents a liquid electrolyte with a porous medium 131. The shape of battery 100 in these figures is for illustrative purposes only. Also, it will be assumed that cathode 111 is positive of the battery and anode 121 is negative of the battery but this need not be the case and can otherwise be configured.

Rechargeable batteries using highly reactive metal anodes offer high energy density but are prone to dendrite formation during charging. As is represented in FIG. 1C, dendrites 121b are filamentary metal deposits that can grow from the interface 121a of anode 121 through the electrolyte of separate 130 and towards interface 111a of cathode 111. If dendrites 121b reach interface 111a, an internal short circuit will cause a cell failure. Conventional lithium-ion batteries with carbon anodes also face problems with lithium plating (metal deposition on the anode surface) under fast-charge or low-temperature conditions, which can initiate dendrites and/or permanently reduce capacity. These issues are generally caused by uneven ion transport and interfacial conditions that lead to concentration gradients and local current hotspots that promote dendritic formations.

Various approaches have been proposed to address these challenges. For example, some designs incorporate internal resistive heaters or foils to warm the cell at low temperatures, thereby increasing ionic conductivity of the electrolyte and making deposition more uniform. One known “self-heating” battery structure embeds a thin nickel foil as a heating element within the cell and uses short electrical pulses to rapidly raise the core temperature of the battery. While such internal heating can enable fast charging in cold environments, it requires additional metal components and complex switching circuitry, and it introduces parasitic weight or volume in the cell. Other prior solutions have focused on modifying the electrolyte or separator to suppress dendrites such as by adding additives that form a stronger solid-electrolyte interphase (SEI) on an anode, or using ceramic separators to mechanically block dendrite penetration. However, these chemical/mechanical approaches do not actively adapt to operating conditions in real time and can be ineffective once nucleation of a dendrite has begun.

### BRIEF SUMMARY

The present disclosure is generally directed to a photonic enhanced battery. A rechargeable battery can include one or more cells that incorporate one or more optical waveguides that deliver electromagnetic radiation into the cell. The electromagnetic radiation can improve ionic transport, heat the cell and/or suppress dendrite formation or its growth. An optical waveguide may be coupled at an edge of the cell's separator to direct the electromagnetic radiation between the cell's electrodes or added through various configurations.

In some embodiments, a photonic enhanced battery may include a cathode, an anode, a separator between the cathode and the anode, an optical waveguide that is optically coupled to the separator at an edge of the separator and an electromagnetic radiation source that is configured to output electromagnetic radiation through the optical waveguide for delivery into the separator.

In some embodiments, the anode comprises lithium.

In some embodiments, the separator comprises a solid electrolyte.

In some embodiments, the separator comprises a porous material and a liquid electrolyte.

In some embodiments, the optical waveguide is an optical fiber.

In some embodiments, the optical fiber has a core that is in direct contact with the edge of the separator.

In some embodiments, the optical waveguide is a planar coupler.

In some embodiments, the electromagnetic radiation comprises infrared light and visible light.

In some embodiments, the electromagnetic radiation is transverse-magnetic polarized relative to an interface between the anode and the separator.

In some embodiments, the optical waveguide includes a polarizer that causes the electromagnetic radiation to be transverse-magnetic polarized.

In some embodiments, the battery includes a controller that causes the electromagnetic radiation source to output infrared light and visible or ultraviolet light.

In some embodiments, the controller is configured to cause the electromagnetic radiation source to output the infrared light prior to outputting the visible or ultraviolet light.

In some embodiments, the battery includes a casing and the optical waveguide is secured within the casing.

In some embodiments, a photonic enhanced battery includes at least one cell. Each cell includes a separator for separating a cathode and an anode. The photonic enhanced battery also includes at least one electromagnetic radiation source that is configured to output electromagnetic radiation into the separator of each of the at least one cell.

In some embodiments, a method for controlling dendrites within a battery cell includes detecting that the battery cell is being charged, activating an electromagnetic radiation source to output electromagnetic radiation and delivering the electromagnetic radiation into a separator of the battery cell via an edge of the separator while the battery is being charged.

In some embodiments, activating the electromagnetic radiation source to output the electromagnetic radiation includes initially outputting a first wavelength of electromagnetic radiation and subsequently outputting one or more additional wavelengths of electromagnetic radiation.

In some embodiments, the first wavelength of electromagnetic radiation is infrared light.

In some embodiments, the first wavelength of electromagnetic radiation is output until a temperature exceeds a threshold and the one or more additional wavelengths of electromagnetic radiation are output after the temperature exceeds the threshold.

In some embodiments, the electromagnetic radiation is delivered into the separator via one or more optical waveguides.

In some embodiments, the electromagnetic radiation is visible or ultraviolet light.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

In order to describe the manner in which the above-recited and other advantages and features can be obtained, a more particular description will be rendered by reference to specific embodiments which are illustrated in the appended drawings. These drawings depict only typical embodiments and are not therefore to be considered to be limiting.

FIGS. 1A and 1B provide examples of common battery cell structures.

FIG. 1C provides an example of dendrites may form within a battery cell.

FIG. 2 provides an example of a battery having a cell that incorporates an optical waveguide in accordance with one or more embodiments of the present disclosure.

FIG. 2A provides an example of how an optical fiber may be used as an optical waveguide in accordance with one or more embodiments of the present disclosure.

FIG. 2B provides an example of how an optical waveguide may be incorporated into a battery cell in accordance with one or more embodiments of the present disclosure.

FIG. 2C provides another example of a battery having a cell that incorporates an optical waveguide in accordance with one or more embodiments of the present disclosure.

FIG. 2D provides an example of an optical waveguide that includes a polarizer.

FIG. 3 provides an example of how electromagnetic radiation delivered via an optical waveguide can induce evanescent fields at the surface of the electrodes.

FIG. 4 is a block diagram of example circuitry of an electromagnetic radiation source that may be used in a battery configured in accordance with one or more embodiments of the present disclosure.

FIG. 5 provides another example of a battery having a cell that incorporates an optical waveguide in accordance with one or more embodiments of the present disclosure.

FIGS. 6 and 6A provide another example of a battery having a cell that incorporates an optical waveguide in accordance with one or more embodiments of the present disclosure.

FIG. 7 provides an example of a battery having a cell that incorporates an electromagnetic radiation source at an edge of the separator in accordance with one or more embodiments of the present disclosure.

### DETAILED DESCRIPTION

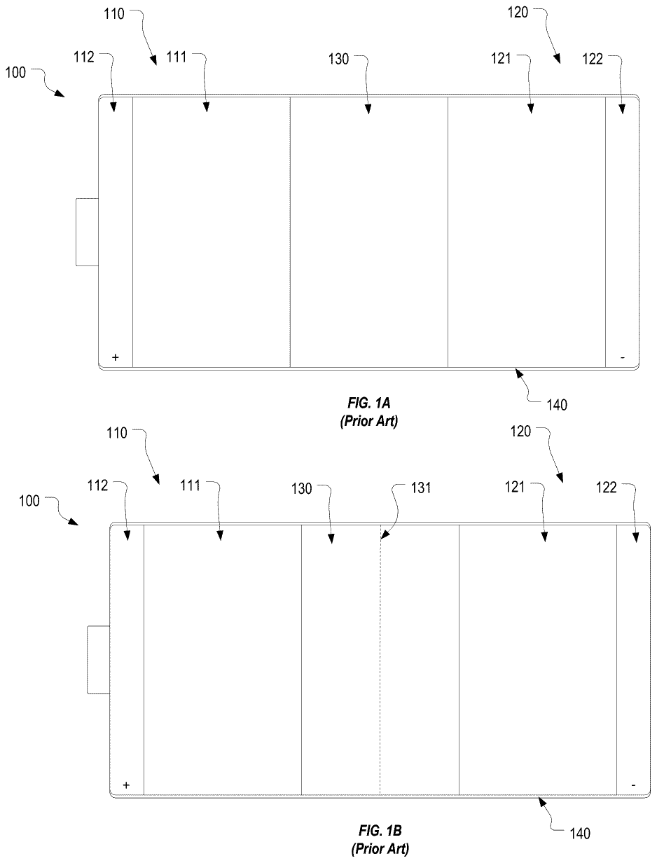

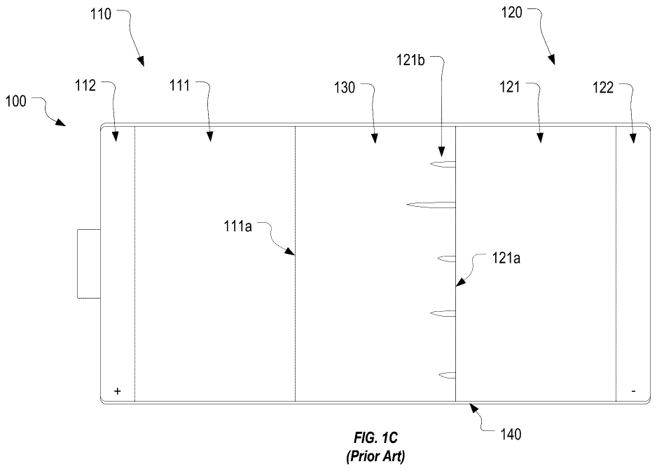

Embodiments of the present disclosure can be implemented in a wide variety of batteries, including batteries with different chemistries and structural designs. The described embodiments should therefore be considered as examples only. Also, even though the battery in each of the described embodiments includes a single cell, the term “battery” should be construed as encompassing one or more cells. Accordingly, embodiments of the present disclosure encompass batteries having any reasonable number of cells, any or all of which may be configured in accordance with the techniques described herein. Additionally, the depicted embodiments are based on FIG. 1A in which separator 130 is a solid electrolyte. However, the depicted embodiments should be construed as also representing embodiments where a different configuration of separator 130 is used.

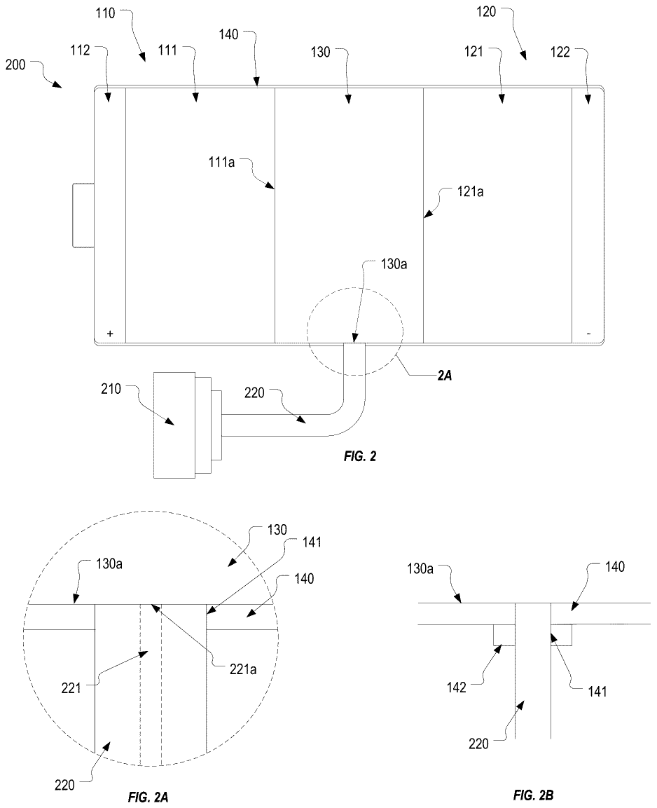

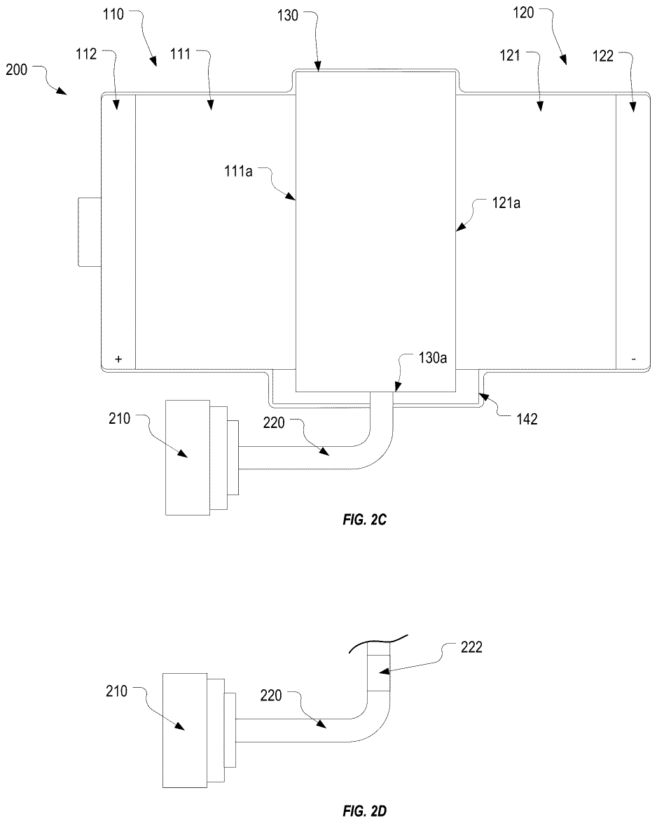

FIG. 2 provides an example of battery 200 that is based on battery 100 of FIG. 1A but is configured in accordance with one or more embodiments of the present disclosure. It is assumed that battery 200 has a single solid-state lithium cell such that anode 121 is formed of a lithium metal. Separator 130 could be formed of any suitable material such as a ceramic (Li₇La₃Zr₂O₁₂ (LLZO)), a glassy sulfide (e.g., Li₂S—P₂S₅), a polymer (e.g., a polyethylene oxide (PEO) based polymer with lithium salt), etc. However, any suitable chemistry could be used for cathode 111, separator 130 and anode 121. For example, embodiments of the present disclosure may also be particularly suitable for sodium-ion or sodium-metal batteries or lead-acid batteries. Embodiments of the present disclosure are also suitable for any separator medium including liquid-filled porous separator, gel polymer electrolyte, solid polymer electrolyte, or solid electrolyte. Embodiments of the present disclosure may also be implemented on batteries where the anode is not initially formed such as batteries where the anode is formed during the first charging.

In accordance with embodiments of the present disclosure, battery 200 also includes an electromagnetic radiation source 210 and an optical waveguide 220. Optical waveguide 220 is coupled at an edge 130a of separator 130 so as to direct electromagnetic radiation into separator 130.

Electromagnetic radiation source 210 can be any suitable component(s) or system(s) for outputting electromagnetic radiation through optical waveguide 220, or similar electromagnetic radiation conducting medium. In some embodiments, electromagnetic radiation source 210 may be capable of outputting electromagnetic radiation along a range of the electromagnetic spectrum (e.g., ultraviolet, visible and infrared light). For example, electromagnetic radiation source 210 could be one or more tunable laser diodes, an array of laser diodes, one or more light emitting diodes, etc.

Optical waveguide 220 can be any suitable component for carrying electromagnetic radiation such as a fiber, a waveguide film, a microprism array, etc. In some embodiments, optical waveguide 220 may be configured to carry a range of wavelengths (e.g., ultraviolet, visible and infrared light). For example, optical waveguide 220 could be a multimode silica fiber with a core diameter compatible with ultraviolet, visible and infrared wavelengths.

As represented in FIG. 2A, in some embodiments, optical waveguide 220 may be in the form of an optical fiber having a core 221 with an end 221a that is placed in direct optical contact with edge 130a. In some embodiments, casing 140 can include an opening 141 through which optical waveguide 220 may insert and within which optical waveguide 220 may be secured to maintain this direct optical contact with edge 130a.

As represented in FIG. 2B, in some embodiments, casing 140 may be modified to include a mounting structure 142 that at least partially forms opening 141 and can be configured to form a tight coupling/seal with optical waveguide 220. For example, optical waveguide 220 could form a friction or clamp fit within mounting structure 142 or could be adhered, welded or otherwise sealed (e.g., via a glass-to-metal seal or polymer gasket) to mounting structure 142. FIG. 2C provides another example in which mounting structure 142 is formed within casing 140 and around a protruding portion of separator 130. For example, the width of separator 130 may be increased relative to the widths of cathode 111 and anode 121 along a least a portion of the periphery of battery 200 to expose sides of separator 130 to or against which mounting structure 142 may be coupled or positioned.

In some embodiments, optical waveguide 220 could be integrally formed with separator 130. For example, separator 130 could be co-extruded with a transparent edge strip that functions as optical waveguide 220.

In some embodiments, electromagnetic radiation source 210 and/or optical waveguide 220 can be configured to polarize the electromagnetic radiation. For example, optical waveguide 220 could be a polarization-maintaining fiber that maintains a polarization generated by electromagnetic radiation source 210. As another example, optical waveguide 220 could include a polarizer 222 such as is shown in FIG. 2D. In some embodiments, the electromagnetic radiation can be transverse-magnetic polarized relative to interfaces 111a and 121a. More particularly, the electromagnetic radiation can be transverse-magnetic polarized so that it is oriented perpendicular to the lithium surface of interface 121a. In some embodiments, the electromagnetic radiation could alternatively be transverse-electric polarized relative to interfaces 111a and 121a.

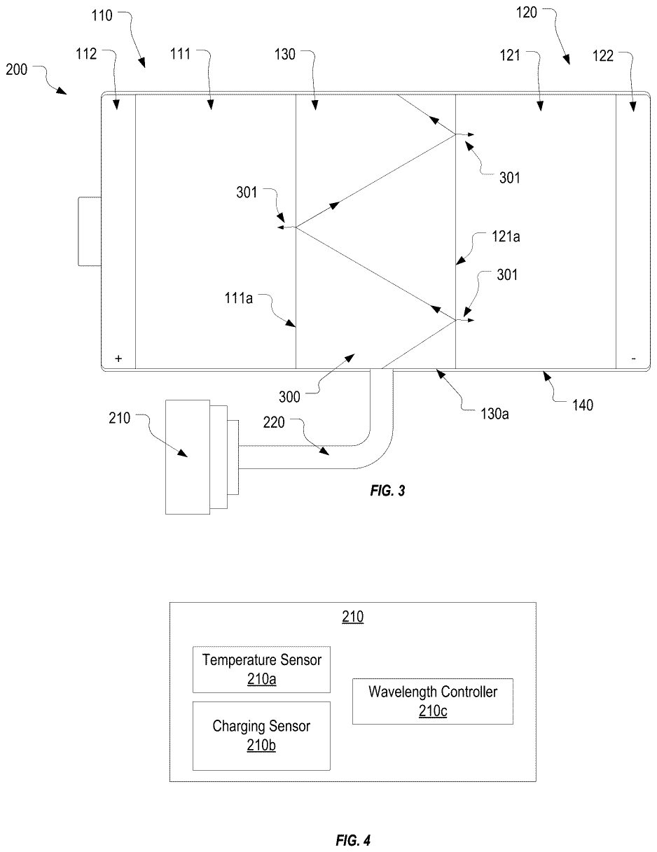

FIG. 3 provides an example of how battery 200 can inhibit the formation and/or growth of dendrites. In FIG. 3, electromagnetic radiation source 210 and optical waveguide 220 are shown as delivering electromagnetic radiation 300 into separator 130 through edge 130a. In some embodiments, electromagnetic radiation 300 may include wavelengths in the visible and/or ultraviolet range (e.g., 532 nm green light). Electromagnetic radiation 300 can propagate across separator 130. As it does so, it will reflect off interfaces 111a and 112a. As electromagnetic radiation 300 reflects, an evanescent field 301 is induced and will penetrate a short distance into cathode 111 and anode 121. Of primary relevance, evanescent field 301 conveys power into the lithium metal of anode 121. The strength of evanescent field 301 and therefore the amount of power transferred to anode 121 at interface 121a can be enhanced by the transverse magnetic polarization of electromagnetic radiation 300 as described above.

By delivering power to interface 112a, electromagnetic radiation 300 can inhibit the formation or growth of dendrites. For example, during charging of battery 200, lithium ions travel from cathode 111 through separator 130 and plate onto anode 121. Dendrites form due to uneven plating. However, by inducing evanescent field 301, electromagnetic radiation 300 reduces or eliminates uneven plating. For example, it is believed that if electromagnetic radiation 300 includes a visible or ultraviolet component, it photolyzes or alters the solid-electrolyte interphase (SEI) on the lithium, making that interphase more ionically conductive and uniform. Simultaneously, it is believed that any nascent dendrite that begins to grow into separator 130 will experience evanescent field 301, which can locally heat it or cause enhanced ionic flux around it, thereby smoothing it out. As a result, the lithium ions are believed to plate substantially uniformly across interface 121a of anode 121 rather than concentrating at random points. In other words, by leveraging optical waveguide 220 to induce evanescent fields 301, the deposition profile essentially flattens to prevent the runaway growth of any single protrusion into a dendrite.

In some embodiments, electromagnetic radiation source 210 and optical waveguide 220 may also or alternatively be used to heat battery 200. For example, electromagnetic radiation source 210 may be configured to output infrared light so that the infrared light is delivered directly into separator 130 where it will in turn directly heat cathode 111, separator 130 and anode 121. Accordingly, the infrared light can function as an internal heater so that the entire battery 200 need not be heated to avoid the challenges of charging in colder temperatures. This internal heating may be particularly beneficial when charging at high voltages and/or currents (e.g., during fast charging).

More particularly, because optical waveguide 220 delivers infrared light directly into the core of the battery cell, separator 130 and interfaces 111a and 121a can be warmed rapidly and uniformly, without having to heat the entire cell from the outside. Raising the internal temperature by even 5-15° C. improves the lithium-ion conductivity of separator 130 exponentially and decreases plating overpotential at anode 121. Thus, before or during a fast-charge cycle, infrared light may be used to prewarm or maintain the internal temperature of battery 200.

In some embodiments, additional synergistic benefits may be obtained by both heating and inducing evanescent fields 301. For example, after or during the heating phase, electromagnetic radiation source 210 may provide a visible/ultraviolet component to directly stabilize interface 121a as described above. Although infrared light itself contributes to uniform plating on interface 121a (e.g., by eliminating cold spots that can foster dendrites), the combination of thermal and non-thermal optical effects offers a synergistic solution. In some embodiments, and to facilitate this synergy, electromagnetic radiation source 210 may emit infrared light (e.g., 808 nm) and visible light (e.g., 532 nm) through a single or multiple cores/channels of optical waveguide 220.

Notably, these benefits can be obtained by coupling optical waveguide 220 solely at edge 130a of separator 130. In some embodiments, it is not necessary to penetrate or coat edge 130a or any other surface of separator 130. As such, the use of optical waveguide 220 may not introduce any contamination or side reactions within battery 200. Additionally, optical waveguide 220 can provide these benefits without requiring any modification to cathode 111, anode 121 or separator 130.

FIG. 4 provides an example of control components that electromagnetic radiation source 210 may include in some embodiments. For example, in some embodiments, electromagnetic radiation source 210 may include (or be interfaced with) a temperature sensor 210a that can sense (whether directly or indirectly) the internal temperature of battery 200. In some embodiments, electromagnetic radiation source 210 may include (or be interfaced with) a charging sensor 210b for detecting when battery 200 is being charged (e.g., by sensing a voltage and/or current between current collectors 112 and 122). In some embodiments, electromagnetic radiation source 210 may include a wavelength controller 210c for controlling the wavelength of electromagnetic radiation that is output via optical waveguide 220. In some embodiments, wavelength controller 210c can leverage charging sensor 210b to determine when battery 200 is being charged and in response can output visible or ultraviolet light to induce evanescent fields 301 to inhibit dendrite formation such that battery 200 has an anti-dendrite formation control design. In some embodiments, wavelength controller 210c can also leverage temperature sensor 210a to determine whether battery 200 is cold during charging and if so, can output infrared light separately from, prior to or in conjunction with outputting visible or ultraviolet light. In some embodiments, electromagnetic radiation source 210 could be powered by battery 200. In some embodiments, electromagnetic radiation source 210 could be powered from an external source (e.g., from the charger).

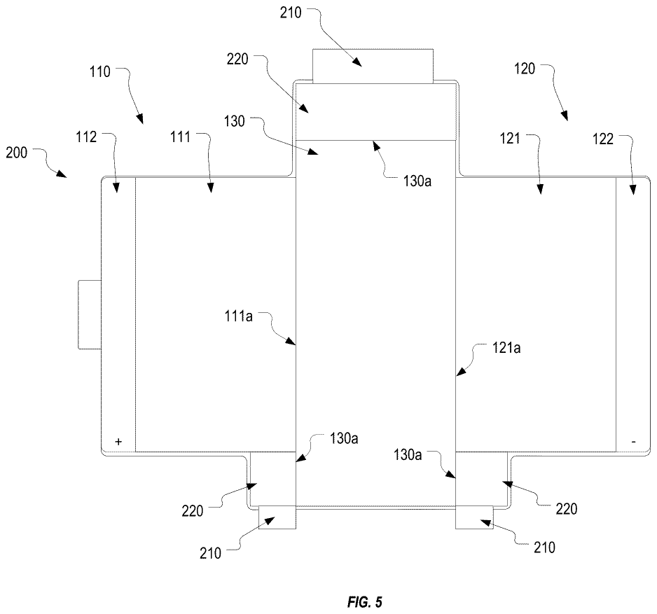

FIG. 5 illustrates a variation of battery 200 in which optical waveguide 220 is in the form of a planar coupler. In such embodiments, separator 130 may have an expanded width to create an increased edge 130a along which optical waveguide 220 may be positioned. In such embodiments, optical waveguide 220 could be formed of a material with a similar refractive index as separator 130 (e.g., a sapphire or high-index glass prism or plate) to facilitate efficient transfer of electromagnetic radiation through edge 130a. Electromagnetic radiation source 210 may inject light directly into optical waveguide 220 such as via a polished facet or a diffraction grating on an external surface of optical waveguide 220. Due to the increased interface between optical waveguide 220 and edge 130a, the electromagnetic radiation will be delivered across a broader area without relying on scattering.

The embodiments represented in FIG. 5 may also permit introduction of multiple beams or polarizations of electromagnetic radiation into separator 130. For example, optical waveguide 220 in the form of a planar coupler could have segmented regions or diffraction gratings that couple different wavelengths at different angles. For example, infrared light might be coupled at normal incidence to primarily traverse and heat separator 130, while visible or ultraviolet light might be coupled at a steep angle to undergo total internal reflection (or impingement) along interface 121a.

Although the above-described techniques focus on interface 121a of anode 121, the techniques can also provide benefits at interface 111a of cathode 111. For example, illuminating interface 111a, whether via infrared light or visible/ultraviolet light may lower the impedance of cathode 111 to cause lithium ions to be extracted more efficiently. For example, in the case of a sulfur-based cathode 111, continuous low-level illumination may keep polysulfide reactions more homogeneous.

In any of the above-described embodiments, multiple optical waveguides 220 may be used. For example, a first optical waveguide 220 may be configured to maximize the interactions with interface 121a of anode 121, and a second optical waveguide 220 may be configured to maximize the interactions with interface 111a of cathode 111. In some embodiments, this could be accomplished by positioning the first and second optical waveguides 220 on different sides/portions of separator 130 and tailoring the polarization and angle of the respective electromagnetic wavelengths for interfaces 121a and 111a respectively. In some embodiments, this may optimize charging, minimize dendrite formation and/or improve ionic conductivity.

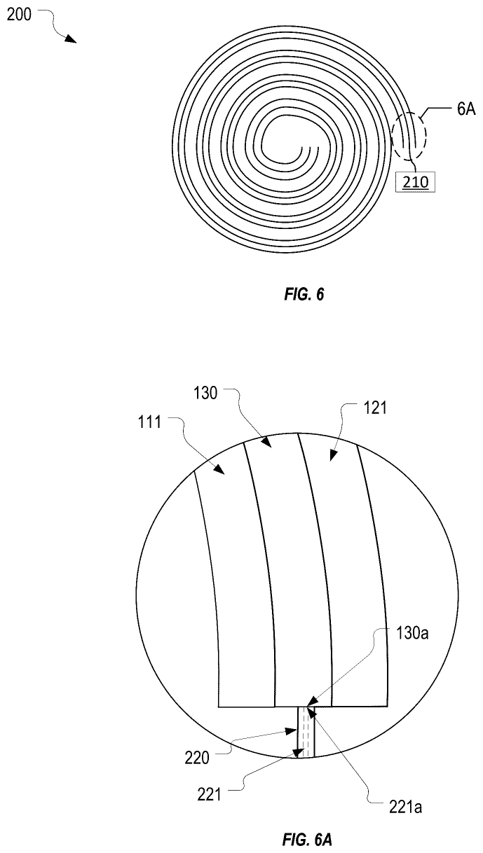

FIGS. 6 and 6A illustrate how the above-described techniques could be implemented when battery 200 has a cylindrical cell configuration (or jelly-roll design). As shown in FIG. 6A, optical waveguide 220 could be positioned against edge 130a of the coiled separator 130. In some embodiments, optical waveguide 220 could be positioned such that end 221a of core 221 is in a central region on the cylindrical shape to better facilitate even distribution of electromagnetic radiation in separator 130. Although not shown, in some embodiments, optical waveguide 220 could extend in a spiral shape along the top (or bottom) edge 130a (relative to the height of the cylindrical shape) of separator 130 and may therefore emit electromagnetic radiation along the spiral shape of separator 130 (as opposed to only at the outer edge or end of separator 130).

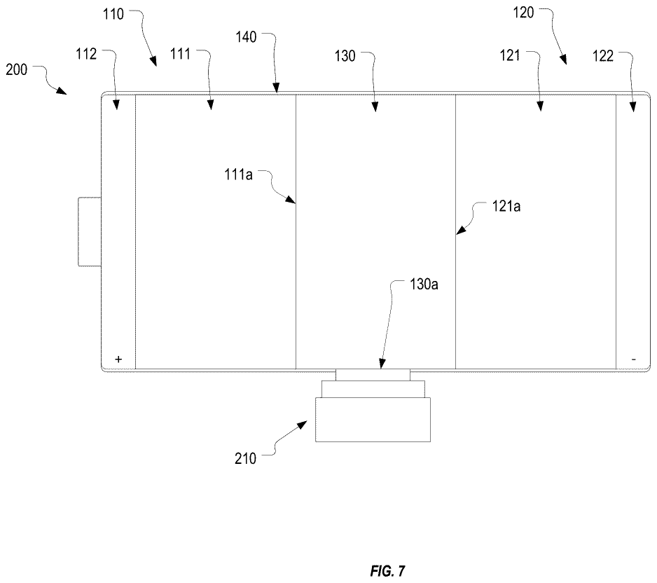

FIG. 7 illustrates a variation of battery 200 in which optical waveguide 220 is omitted and electromagnetic radiation source 210 is placed directly against edge 130a of separator 130. For example, in such embodiments, electromagnetic radiation source 210 could be an LED or other light source that is secured within or to casing 140 in any of the manners described above or otherwise held against edge 130a.

In some embodiments, electromagnetic radiation source 210 and possibly optical waveguide 220 can be formed into/on edge 130a using a variety of manufacturing techniques. For example, electromagnetic radiation source 210 and/or optical waveguide 220 could be formed via lithography (e.g., photolithography, electron-beam lithography, nanoimprint lithography, etc.), etching (e.g., dry etching, wet etching, etc.), deposition (e.g., chemical vapor deposition, physical vapor deposition, atomic layer deposition, etc.), doping (e.g., ion implantation, diffusion, etc.), wafer bonding (e.g., direct bonding, adhesive bonding, hybrid bonding, etc.), planarization (e.g., chemical mechanical polishing, etc.), 3D printing (e.g., two-photon polymerization, inkjet printing, etc.), packaging and integration (flip-chip bonding, fiber coupling, thermal management solutions, etc.), etc.

In some embodiments, evanescent fields 301 may be leveraged to enhance ionic conduction through gaps that may exist between anode 121 (or possibly cathode 111) and separator 130 (particularly when separator 130 is a solid electrolyte). In traditional approaches, high compression forces are used to minimize such gaps. However, by inducing evanescent fields 301, the gaps'impact on ionic conductivity can be reduced thereby reducing, or possibly eliminating, the need for compression forces. In other words, evanescent fields 301 can cause any gaps to be sufficiently conductive so that it is not necessary to reduce or eliminate the gaps.

In some embodiments, a controller may be configured to perform a process for efficiently charging a battery cell such as battery 200. In some embodiments, the controller could be part of electromagnetic radiation source 210. However, the controller could be a separate component including a component external to the battery (e.g., a component of the charger).

During charging, the controller can monitor the battery cell's state such as its temperature, charge rate and/or health. When a predetermined condition is met, such as when charging at a high current or charging when the battery cell temperature is low, the controller can activate an electromagnetic radiation source. For example, if the battery cell is at low temperature, the controller may introduce electromagnetic radiation (e.g., an infrared or broad-spectrum light) to heat the battery cell's interior. Once the cell is sufficiently warm or concurrently during this heating, the controller may introduce electromagnetic radiation (e.g., visible and/or ultraviolet light) to suppress dendrites and improve interface kinetics as described above. These two optical functions can occur sequentially or simultaneously.

The controller may continue to introduce electromagnetic radiation during charging such as throughout the high-risk period (e.g., the bulk of a fast charge cycle). When charging is complete or conditions normalize, (e.g., the current drops to a trickle or the cell temperature returns to nominal range), the controller can deactivate the electromagnetic radiation source including during discharge.

The controller can ensure that the optical enhancement is used on-demand, which maximizes its benefits (fast charge, dendrite safety, cold performance) while minimizing any unnecessary stress. The controller can implement the process for a single cell or for multiple cells in a battery. For example, the controller may interface with one or more electromagnetic radiation sources that deliver electromagnetic radiation to multiple optical waveguides. In some embodiments, each optical waveguide may be coupled to a single cell, whereas in some embodiments, a single optical waveguide may be used to deliver electromagnetic radiation to multiple cells such as using optical splitting. In some embodiments, the controller can sense conditions separately for each cell and can therefore activate electromagnetic radiation on a per-cell basis.

Embodiments of the present invention may also be implemented outside of the charging context. For example, electromagnetic radiation could be delivered to the separator during the initial cycles of a battery cell while the solid-electrolyte interphase is formed to thereby create a better solid-electrolyte interphase. As another example, electromagnetic radiation could be delivered during idle storage of a battery to redistribute any deposits that may have formed.

Embodiments of the present disclosure may be implemented to improve the efficiency, performance, safety and/or life cycle of a rechargeable battery. For example, embodiments can enable safer and faster-charging batteries without altering the electrode materials or introducing large sacrificial components. The optical waveguide is a passive, inert addition that does not participate in the battery electrochemistry when electromagnetic radiation is not delivered. When activated, however, it provides on-demand and instant internal heating and interface stabilization. These embodiments are adaptable across cell formats (pouch, cylindrical, prismatic, etc.) because the optical waveguide can be routed through an existing seal, along the side of the jelly-roll winding, or to any other reasonable position.

In comparison to prior art approaches, embodiments of the present disclosure enable extreme fast charging without risk of shorting by actively mitigating dendrite formation. Embodiments of the present disclosure also improve low-temperature performance, allowing charging and discharging in sub-freezing conditions by internally heating the cell (thus avoiding the long wait times or external pack heaters typically needed). Embodiments of the present disclosure are also inherently safe because the electromagnetic radiation can be modulated or pulsed rapidly and turned off instantly, and it does not introduce high currents or uncontrolled chemical additives into the cell. In solid-state cells, embodiments of the present disclosure address one of the main impediments, high interfacial resistance at room temperature, by locally heating and photoactivating the interface, thereby unlocking higher power output. In liquid cells, embodiments of the present disclosure serve as an “active separator” that not only separates but also manages the microenvironment of the cell in real time.

Furthermore, embodiments of the present disclosure do not require scaling the cell down or altering its fundamental makeup. Instead, embodiments of the present disclosure can be retrofitted or integrated into existing designs with minimal changes (e.g., adding a fiber feed-through in a standard 21700 lithium-ion cell casing, or including a thin glass coupler on the side of a ceramic electrolyte sheet).

1. A photonic enhanced battery for inducing an evanescent field to inhibit formation of dendrites comprising:
a cathode;
an anode;
a separator between the cathode and the anode;
an optical waveguide having a first end and a second end, the first end being in direct optical contact with an edge of the separator; and
an electromagnetic radiation source that is configured to output electromagnetic radiation comprising one or more of infrared, visible and ultraviolet light, into the second end of the optical waveguide, wherein the optical waveguide is configured to cause the electromagnetic radiation to be carried through the optical waveguide and emitted from the first end through the edge of the separator for delivery into the separator to thereby cause the electromagnetic radiation to propagate through the separator to induce an evanescent field at the anode due to the electromagnetic radiation reflecting off an interface between the anode and the separator.

2. The photonic enhanced battery of claim 1, wherein the anode comprises lithium.

3. The photonic enhanced battery of claim 1, wherein the separator comprises a solid electrolyte.

4. The photonic enhanced battery of claim 1, wherein the separator comprises a porous material and a liquid electrolyte.

5. The photonic enhanced battery of claim 1, wherein the electromagnetic radiation also induces an evanescent field at the cathode due to the electromagnetic radiation reflecting off an interface between the cathode and the separator. wherein the optical waveguide is an optical fiber.

6. The photonic enhanced battery of claim 1, wherein the optical waveguide is an optical fiber and the optical fiber has a core that is in direct contact with the edge of the separator.

7. The photonic enhanced battery of claim 1, wherein the optical waveguide is a planar coupler.

8. The photonic enhanced battery of claim 1, wherein the electromagnetic radiation comprises infrared light and one or both of visible and ultraviolet light.

9. The photonic enhanced battery of claim 8, wherein the electromagnetic radiation is transverse-magnetic polarized relative to an the interface between the anode and the separator.

10. The photonic enhanced battery of claim 9, wherein the optical waveguide includes a polarizer that causes the electromagnetic radiation to be transverse-magnetic polarized.

11. The photonic enhanced battery of claim 1, further comprising:
a controller that causes the electromagnetic radiation source to output infrared light and visible or ultraviolet light.

12. The photonic enhanced battery of claim 11, wherein the controller is configured to cause the electromagnetic radiation source to output the infrared light prior to outputting the visible or ultraviolet light.

13. The photonic enhanced battery of claim 1, further comprising:
a casing;
wherein the optical waveguide is secured within the casing.

14. A photonic enhanced battery for inducing an evanescent field to inhibit formation of dendrites comprising:
at least one cell, each cell comprising:
a cathode;
an anode;
a separator between the cathode and the anode; and
an optical waveguide having a first end and a second end, the first end being in direct optical contact with an edge of the separator; and
at least one electromagnetic radiation source that is configured to output electromagnetic radiation, comprising one or more of infrared, visible and ultraviolet light, into the second end of each optical waveguide, wherein each optical waveguide is configured to cause the electromagnetic radiation to be carried through the optical waveguide and emitted from the first end through the edge of the respective separator for delivery into the respective separator to thereby cause the electromagnetic radiation to propagate through the respective separator to induce an evanescent field at the respective anode due to the electromagnetic radiation reflecting off an interface between the respective anode and the respective separator.

15. A method for controlling dendrites within a battery cell, the method comprising:
detecting that the battery cell is being charged, the battery cell comprising:
a cathode;
an anode;
a separator between the cathode and the anode; and
an optical waveguide having a first end and a second end, the first end being in direct optical contact with an edge of the separator;
activating an electromagnetic radiation source to output electromagnetic radiation, comprising one or more of infrared, visible and ultraviolet light, into the second end of the optical waveguide, wherein the optical waveguide is configured to cause the electromagnetic radiation to be carried through the optical waveguide and emitted from the first end through the edge of the separator for delivery into the separator while the battery cell is being charged to thereby cause the electromagnetic radiation to propagate through the separator to induce an evanescent field at the anode due to the electromagnetic radiation reflecting off an interface between the anode and the separator.

16. The method of claim 15, wherein activating the electromagnetic radiation source to output the electromagnetic radiation comprises initially outputting a first wavelength of electromagnetic radiation and subsequently outputting one or more additional wavelengths of electromagnetic radiation.

17. The method of claim 16, wherein the first wavelength of electromagnetic radiation comprises infrared light.

18. The method of claim 16, wherein the first wavelength of electromagnetic radiation is output until a temperature exceeds a threshold and the one or more additional wavelengths of electromagnetic radiation are output after the temperature exceeds the threshold.

19. The method of claim 15, wherein the optical waveguide is an optical fiber.

20. The method of claim 15, wherein the electromagnetic radiation comprises infrared light and one or both of visible and ultraviolet light.
